(19) United States
(12) Patent Application Publication
(10) Pub. No.: US 2003/0218601 A1
(43) Pub. Date: Nov. 27, 2003

(54) Image display and computer readable program

(75) Inventor: Chihiro Tsukinokizawa, Nagano-Ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/375,109

(22) Filed: Feb. 28, 2003

(30) Foreign Application Priority Data
Mar. 26, 2002 (JP) 2002-087006

(51) Int. Cl. G09G 5/00

(52) U.S. Cl. 345/204

(57) ABSTRACT

An image display has an image output portion (401) that forms and displays an optical image in accordance with inputted image signal, a sound output portion (307) that outputs sound in accordance with an inputted sound signal, and an output regulation selector (951) that selects regulation on either one or both of an image output of the image output portion (401) and the sound by the sound output portion (307).

### BACKGROUND OF THE INVENTION

1. Field of the Invention

The present invention relates to an image display which has an image output portion for forming and displaying an optical image in accordance with inputted image signal and a sound output portion for outputting sound in accordance with inputted sound signal, and a computer-readable program for controlling the image display.

2. Description of Related Art

Conventionally, a projector having an electric optical device that modulates a light beam irradiated from a light source in accordance with inputted image signal to form an optical image and a projection optical system that enlarges and projects the optical image has been used.

A computer is connected to such projector to display a computer screen image on a large screen, so that a multi-presentation can be conducted using a computer.

A muting switch is often provided to the projector for suspending presentation etc. When the muting switch is pressed, image output and sound output are regulated.

On the other hand, the projector has recently come to be used for personal home-theater purpose and there is strong demand for a projector suitable for personal use.

However, according to the above-described conventional projector, both of the image output and the sound output are regulated when the muting switch is pressed. On the other hand, in a personal use, it is sometimes preferable that only sound output is regulated while keeping the image display output.

### SUMMARY OF THE INVENTION

An object of the present invention is to provide an image display capable of regulating output of image and sound in accordance with usage such as presentation and personal use, and a computer-readable program used therefor.

In order to attain the above object, an image display according to an aspect of the present invention has: an image output portion that forms and displays an optical image in accordance with inputted image signal; a sound output portion that outputs sound in accordance with an inputted sound signal; and an output regulation selector that selects regulation on either one or both of an image output of the image output portion and the sound by the sound output portion.

According to the above aspect of the present invention, since the output regulation selector is provided, either one or both of the image output and sound output can be regulated, so that output of image and sound can be regulated in accordance with the usage such as presentation and personal use.

In the above, the output regulator may preferably display a predetermined menu screen on the image output portion and select a setting on the menu screen.

The predetermined menu screen refers to a menu screen on which functions such as image setting, e.g. tracking, synchronizing frequency and brightness of the image output portion, and sound setting of output speaker of the sound output are set.

Since the setting is selected and changed on the menu screen, the regulation condition can be easily selected and changed on the menu screen by operating operation switches etc. on the image display on a remote controller.

The above image display may preferably have a fixed image displayer that displays a predetermined fixed image on the image output portion when the image output of the image output portion is regulated.

The fixed image may be a blue image on the entire screen, a fixed image such as a desired picture, photograph, etc.

Since the fixed image is displayed by the fixed image displayer while muting the image output, the viewer does not feel unpleasant unlike the sandstorm-like screen, so that image muting display can be of little annoyance to the viewer.

The above image display may preferably have a regulation displayer that indicates regulation of the image output of the image output portion when the image output of the image output portion is regulated.

The indication of regulation may be a message of, for instance, “image output muting now”.

Since the regulation condition is shown on the image output portion, whether there is no input of the image signal or the image output is regulated can be immediately recognized, so that normal condition can be easily restored.

When the above image display has a controller that controls the image output portion and the sound output portion and a storage storing a software that is operated by the controller in actuating the image display, the output regulation selector, the fixed image displayer and the regulation displayer may preferably be stored in the storage.

Since the respective components are recorded together with the software operated in actuating the image display, the selection of regulation of image or sound and image display during regulation can be conducted together with actuating the image display, the function related to the regulation can be used immediately after actuation.

The image may preferably be a projector having an electric optical device that modulates a light beam irradiated by a light source in accordance with the inputted image signal to form the optical image and a projection optical system that enlarges and projects the optical image.

Such projector has come to be widely used for usage such as personal use, e.g. home theater, and presentation, effectiveness of the present invention can be enhanced.

The present invention can be applied not only as an image display but also as a program for controlling an image display having the image output portion and the sound output portion, where the same function and effect can be obtained.

Further, when the present invention is applied as a program, the program of the present invention can be endowed with the above-described function after writing the program of the present invention on the involatile memory storing the program in actuating the image display, multi-function can be given to a general image display.

### BRIEF DESCRIPTION OF THE DRAWINGS

FIG. 1 is a perspective view of a rear projector as an image display seen from front side according to the present invention;

FIG. 2 is a perspective view of the rear projector seen from rear side;

FIG. 3 is an exploded perspective view of the rear projector seen from rear side, which specifically shows that a back cover is removed from FIG. 2;

FIG. 4 is an exploded perspective view of the rear projector seen from bottom side;

FIG. 5 is a vertical cross section of the rear projector;

FIG. 6 is a perspective view of an interior unit constituting the rear projector seen from rear side;

FIG. 7 is a plan view schematically showing the optical unit;.

FIG. 9 is a block diagram showing a structure of a controller according to the aforesaid embodiment;

FIG. 10 is a flowchart showing a function of the controller according to the aforesaid embodiment;

FIG. 11 is an illustration of an example of menu screen according to the aforesaid embodiment; and

FIG. 12 is an illustration showing an example of function setting selection screen according to the aforesaid embodiment.

### DETAILED DESCRIPTION OF PREFERRED EMBODIMENT(S)

An embodiment of the present invention will be described below with reference to attached drawings.

[1. Primary Arrangement of Rear Projector]

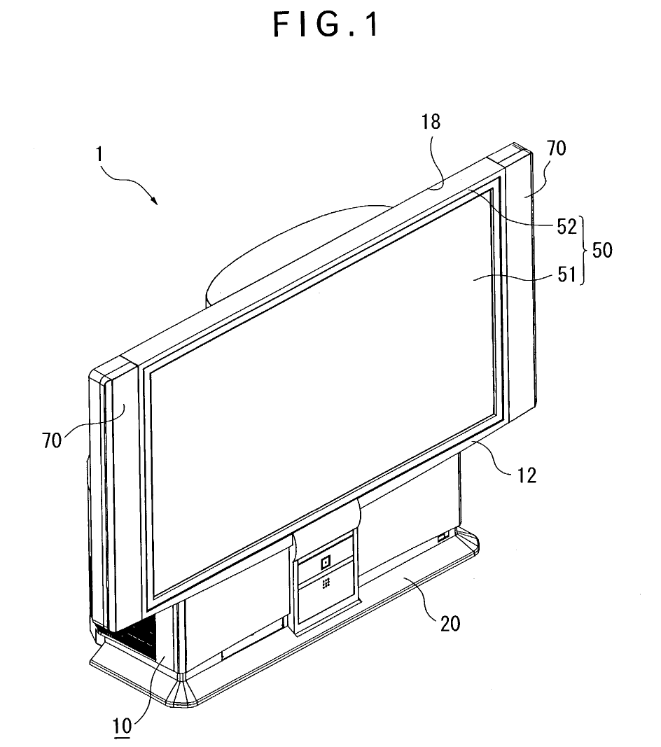

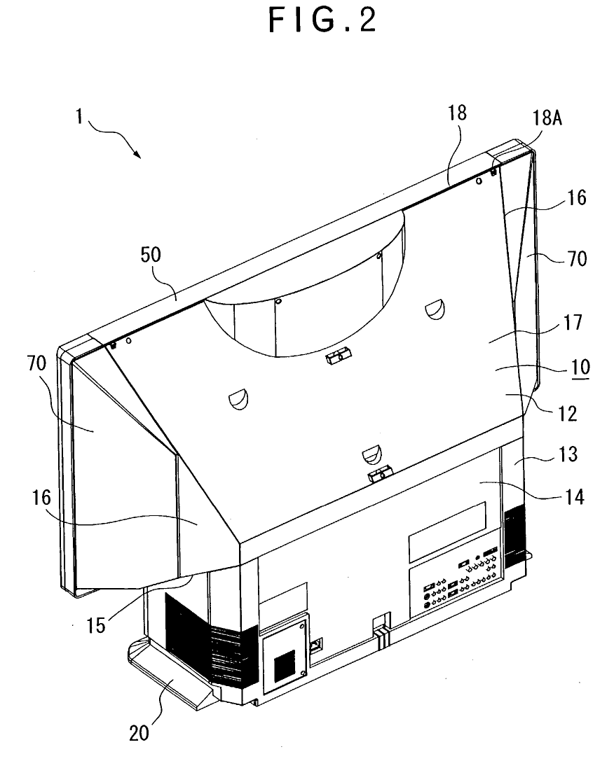

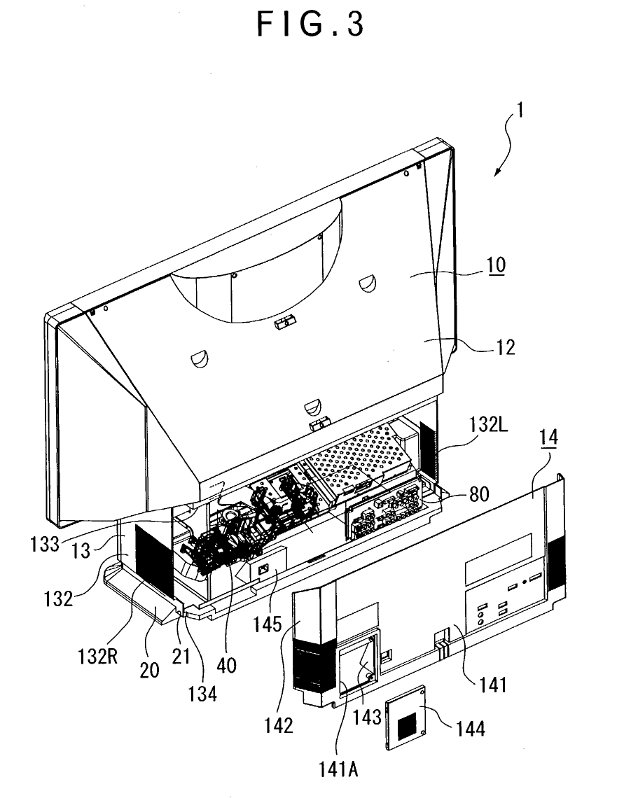

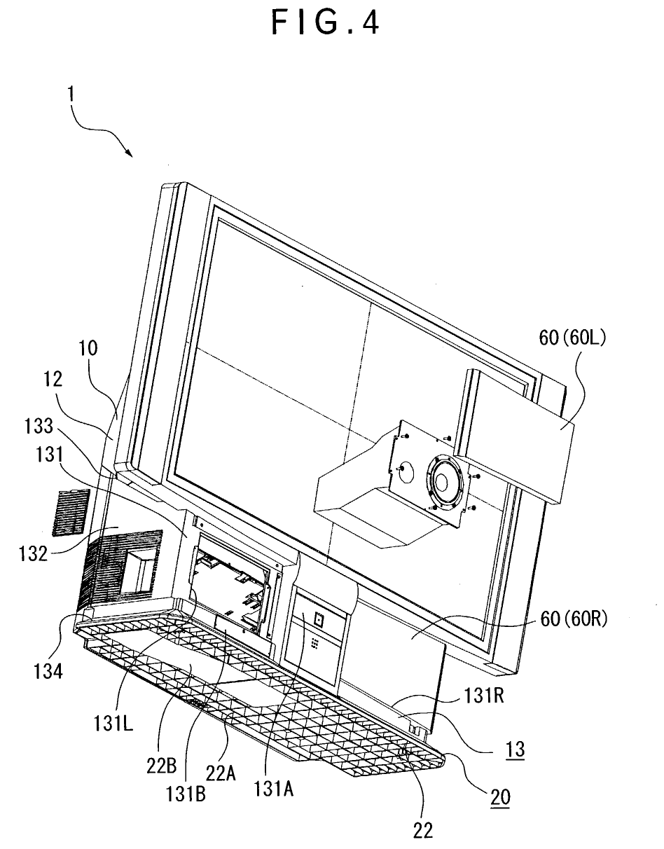

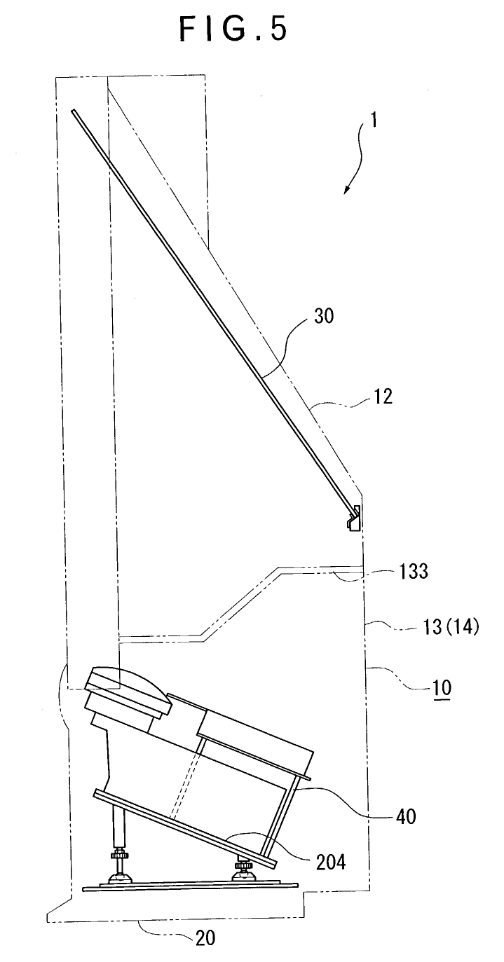

FIG. 1 is a perspective view seen from front side of a rear projector 1 as an image display according to an aspect of the present invention. FIG. 2 is a perspective view of the rear projector 1 seen from rear side thereof. FIG. 3 is an exploded perspective view of the rear projector 1 seen from rear side, which specifically shows that a back cover 14 is removed from FIG. 2. FIG. 4 is an exploded perspective view of the rear projector 1 seen from lower side. FIG. 5 is a vertical cross section showing the rear projector 1.

A primary arrangement of the rear projector 1 will be described below with reference to FIGS. 1 to 5.

As shown in FIGS. 1 to 5, the rear projector 1 modulates a light beam irradiated by a light source in accordance with image information to form an optical image, and enlarges and projects the optical image on a screen, which includes a cabinet 10 constituting a casing, a leg 20 provided on the lower side of the cabinet 10, an interior unit 40 as an image generator located inside the cabinet 10, a reflection mirror 30 also located inside the cabinet 10, and a screen unit 50 exposed on a side of the cabinet 10. The cabinet 10, the interior unit 40, the reflection mirror 30 and the screen unit 50 construct a projector body.

Incidentally, for the convenience of explanation, left side seen from front side is referred to as left and right side seen from front side is referred to as right in the present embodiment.

The cabinet 10 is a casing of synthetic resin for accommodating the interior unit 40 and the reflection mirror 30. As shown in FIG. 3, the cabinet 10 accommodates the interior unit 40 and has a lower cabinet 13 of C-shaped vertical cross section as a first casing covering approximately entire front, upper and lower sides and right and left sides, a back cover 14 covering the rear side and a part of the right and left sides, and an upper cabinet 12 of triangle vertical cross section as a second casing disposed on the upper side of the lower cabinet 13.

The dimension of the lower cabinet 13 in right and left direction along the surface of the screen unit 50 is smaller than the dimension of the upper cabinet 12 in right and left direction along the surface of the screen unit 50.

The back cover 14 is detachably attached to the lower cabinet 13.

As shown in FIG. 4, the lower cabinet 13 includes a front side 131, right and left lateral sides 132, an upper side 133 and a lower side 134.

A central portion 131A bulging toward front side in accordance with projection of a projection lens constituting the interior unit 40 is provided approximately at the center of the front side 131. Rectangular openings 131R and 131L of approximately the same dimension are formed on both sides of the central portion 131A. Woofer boxes 60 (60R and 60L) as a speaker for reproducing low-pitched sound are respectively attached to the openings 131R and 131L. The woofer boxes 60R and 60L are attachable to and detachable from the openings 131R and 131L from the front side.

Incidentally, though not clearly shown in the illustration, a lid 131B is provided on the lower side of the left opening 131L, in which a front-side interface board is provided (not shown in FIG. 4) for a device such as a computer and DVD player can be connected from the front side of the rear projector 1.

Further, as shown in FIG. 3, slit-shaped openings are formed on the right and left lateral sides 132 of the lower cabinet 13. The left opening is an intake opening 132L for introducing a cooling air into the interior of the projector and the right opening is an exhaust opening 132R for discharging the air having introduced and cooled the interior.

The upper side 133 opposes to a lower side of the upper cabinet 12 (described below). The lower side 134 abuts to the receiver surface of the leg 20 (described below).

As shown in FIG. 3, the back cover 14 includes a rear side 141 and right and left lateral sides 142.

A second intake opening 141A for introducing cooling air is formed on the right side (left side seen from rear side) of the rear side 141 of the back cover 14. An air filter 143 is attached to the second intake opening 141A. A cover 144 for shutting the second intake opening 141A provided with the air filter 143 is detachably attached to the opening 141A. An opening for inlet connector 145 is provided on the left side (right side seen from rear side) of the second intake opening 141 A of the rear side 141.

Various device connection terminals such as connector for connecting a computer, a video input terminal and audio-connection terminal are provided on the left side (right side seen from rear side) of the rear side 141 and an interface board 80 is provided on the inner surface of the rear side 141.

Various device-connecting terminals such as a connector for a computer, video input terminal and audio connection terminal are provided on the left side (right side seen from rear side) of the rear side 141 and an interface board 80 is provided on the inside of the rear side 141.

As shown in FIGS. 2 and 5, the upper cabinet 12 is a casing of triangle vertical cross section for accommodating the reflection mirror 30, which includes a lower side 15 of approximately rectangle plate, right and left lateral sides 16 of triangle plate vertically extending from both ends of the lower side 15, a rear side 17 spanning over the right and left sides and slanting toward the lower rear side, and a front side 18 of approximately rectangle plane. Rectangular opening 18A is formed on the planar front side 18. A screen unit 50 covering the opening 18A is attached to the front side 18.

[2. Structure of Interior Unit]

FIG. 8 is a perspective view of the interior unit seen from rear side.

The interior unit 40 is a device for forming a predetermined optical image in accordance with inputted image information and outputting sound and image by amplifying the sound signal added to the image information. The interior unit 40 has an interior unit body 400, a support member 200 made of metal such as aluminum for supporting the interior unit body 400 at a predetermined attitude, a first power source 301, and a second power source 302.

The interior unit body 400 includes an approximately L-shaped optical unit 401 having a not-illustrated light source located on the right side (left side seen from rear side) and extending from the light source toward left side and further front side, and a control board 402 covering a part of the right side of the optical unit 401 and extending from the center to the left side (right side seen from rear side).

The control board 402 is a board having a controller including CPU etc., which controls the drive of the optical device constituting the optical unit 401 in accordance with the inputted image information being electrically connected with the interface board 80 and the front-side interface board provided inside the lid 131B based on the image signal inputted from the input/output terminal of the boards.

The surroundings of the control board 402 are covered with a metal shield 403. The shield 403 covering the control board 402 is attached to the rotary position adjuster 204 spanning over the optical unit 401 through a column-shaped member. The details of the optical unit 401 will be described below.

The first power source 301 is provided on the front side of the light source and on the left side of the partition 205, which includes a first power source block 303 and a lamp driving circuit (ballast) 304 adjacent to the first power source block 303.

The first power source block 303 supplies electric power fed from the outside to the lamp driving circuit 304, the control board 402 etc. through a not-illustrated power cable connected to the inlet connector 145.

The lamp driving circuit 304 supplies electric power fed from the first power source block 303 to the light source lamp constituting the optical unit 401, which is electrically coupled with the light source lamp. The lamp driving circuit 304 is, for instance, wired to a non-illustrated board.

The first power source 301 is covered with a metal shield 305 with right and left sides being opened. The shield 305 prevents leakage of electromagnetic noise. An axial-flow fan 521 for the power source is attached to a center opening of the first power source 301, which blows cooling air in a direction for the first power source 301 to be extended, i.e. from the central portion to the right side. The shield 305 works as a duct for guiding the cooling air.

The second power source 302 is provided in a space on the right side of the partition 205, which has a second power source block 306 and a sound signal amplifier 307 for amplifying the inputted sound signal, which is covered with metal shield 308.

The second power source block 306 supplies electric power fed from the outside to the sound signal amplifier 307 through a non-illustrated power cable connected to the inlet connector 145.

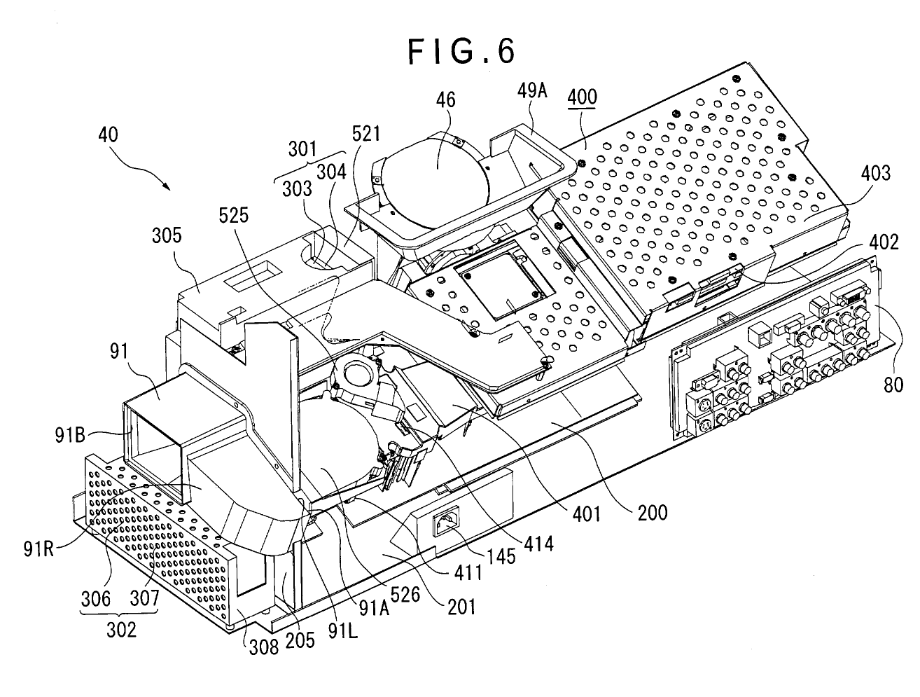

The sound signal amplifier 307 as a sound output is driven by the electric power supplied by the second power source block 307 to amplify the inputted sound signal, which is electrically coupled with the below-described speaker box and the woofer box (not illustrated in FIG. 6). The sound signal amplifier 307 is, for instance, wired to a non-illustrated board.

[3. Structure of Optical unit]

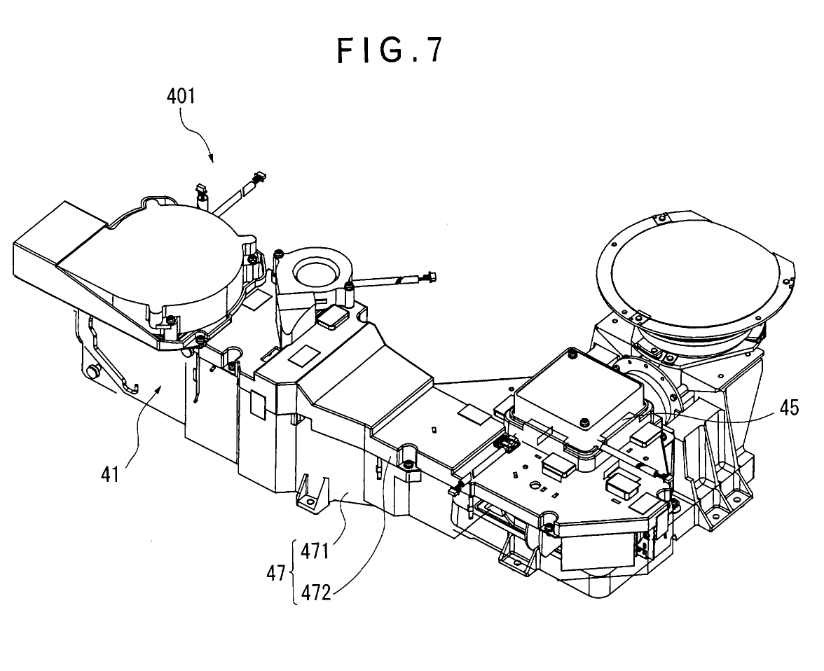

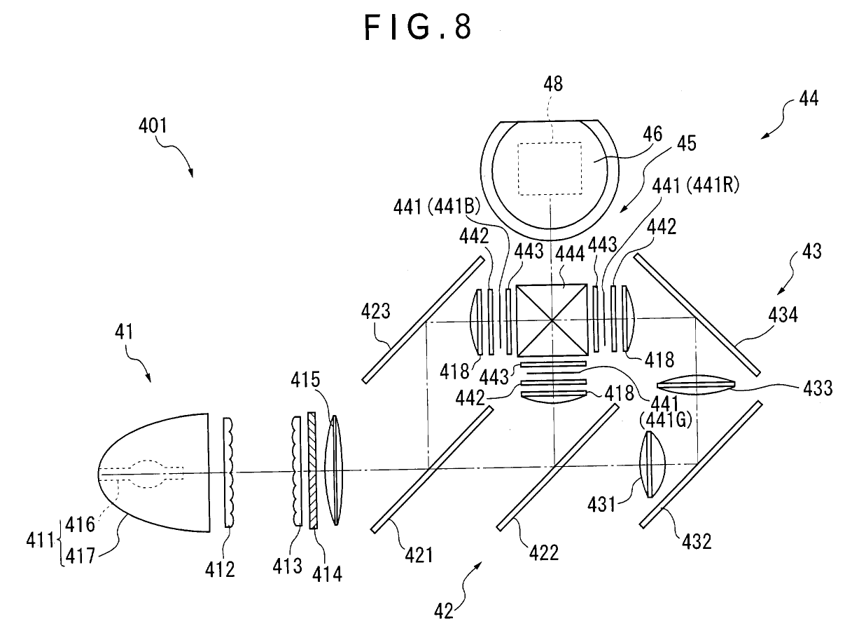

FIG. 7 is a perspective view showing the optical unit 401. FIG. 8 is a plan view schematically showing the optical unit 401.

As shown in FIG. 8, the optical unit 401 as an image output is a unit for optically processing the light beam irradiated by a light source lamp as a component of the light source to form an optical image in accordance with image information, which includes an integrator illuminating optical system 41, a color separating optical system 42, a relay optical system 43, an optical device 44, a right-angle prism 48 and the projection lens 46 as a projection optical system.

The integrator illuminating optical system 41 is a system for substantially uniformly illuminating the image formation area of the three liquid crystal panels 441 constituting the optical device 44 (respectively referred to as liquid crystal panel 441R, 441G and 441B for every color lights of red, green and blue), which includes a light source, a first lens array 412, a second lens array 413, a polarization converter 414 and a superposing lens 415.

The light source has a light source lamp 416 as a radiation light source and a reflector 417, which changes the radial light beam irradiated by the light source lamp 416 into a parallel light beam by the reflector 417 to emit the parallel light beam toward the outside.

A halogen lamp is used as the light source lamp 416. Incidentally, metal halide lamp and a high-pressure mercury lamp etc. may be used instead of the halogen lamp.

A parabolic mirror is used as the reflector 417. Incidentally, a combination of a concave lens for parallelizing nonparallel light reflected by the reflector and ellipsoidal mirror may be used instead of the parabolic mirror.

The first lens array 412 is a plurality of small lenses arranged in matrix, the lenses having substantially rectangular profile viewed from optical axis direction. The respective lenses split the beam emitted from the light source lamp 416 into a plurality of sub-beams. The profile of the respective lenses is approximately similar to the configuration of the image formation area of the liquid crystal panel 441. For instance, when the aspect ratio (ratio of horizontal and vertical dimensions) of the liquid crystal panels 441 is 4:3, the aspect ratio of the respective lenses is also set as 4:3.

The second lens array 413 has approximately the same arrangement as the first lens array 412, where the small lenses are disposed in matrix. The second lens array 413 as well as the superposing lens 415 focuses the image from the respective small lenses of the first lens array 412 onto the liquid crystal panel 441.

The polarization converter 414 is disposed between the second lens array 413 and the superposing lens 415 and is integrated with the second lens array 413 as a unit. The polarization converter 414 converts the light from the second lens array 413 to a single polarized light in order to enhance light utilization efficiency in the optical device 44.

Specifically, the respective sub-beams converted into single polarized light by the polarization converter 414 are substantially superposed on the liquid crystal panel 441 of the optical device 44 by superposing lens 415. Since the rear projector 1 using the liquid crystal panel 441 for modulating polarized light can use only single polarized light, approximately half of the light from the light source lamp 416 emitting other random polarized light cannot be used. Accordingly, by using the polarization converter 414, all of the light emitted from the light source lamp 416 is converted into single polarized light to enhance light utilization efficiency in the optical device 44.

Incidentally, such polarization converter 414 is disclosed in, for instance, Japanese Patent Laid-Open publication No. Hei 8-304739.

The color separating optical system has two dichroic mirrors 421 and 422 and a reflection mirror 423, the dichroic mirrors 421 and 422 separating the plurality of sub-beams irradiated by the integrator illuminating optical system 41 into three color lights of red (R), green (G) and blue (B).

The relay optical system 43 has incident-side lens 431, a relay lens 433 and reflection mirrors 432 and 434, and introduces the red color light separated by the color separating optical system 42 onto the liquid crystal panel 441 R.

At this time, the red light component and the green light component of the light beam irradiated from the illuminating optical integrator system 41 are transmitted through the dichroic mirror 421 of the color separating optical system 42 and the blue light component is reflected by the dichroic mirror 421. The blue light reflected by the dichroic mirror 421 is reflected by the reflection mirror 423, which reaches to the liquid crystal panel 441B for blue-color through a field lens 418. The field lens 418 converts the respective sub-beams emitted from the second lens array 413 into a light beam parallel to central axis (main beam) thereof. The field lenses 418 provided in front of the other liquid crystal panels 441G and 441B function in the same manner.

In the red light and the green light transmitted through the dichroic mirror 421, the green light is reflected by the dichroic mirror 422 to reach the liquid crystal panel 441G for green color through the field lens 418. On the other hand, the red color transmits through the dichroic mirror 422 to pass the relay optical system 43 and reach the liquid crystal panel 441R for red color through the field lens 418.

Incidentally, the relay optical system 43 is used for the red color light in order to prevent decrease in utilization efficiency of light on account of light diffusion caused by longer length of the optical path of the red light than the length of the optical path of the other color lights, in other words, in order to directly transmit the sub-beam incident on the incident-side lens 431 to the field lens 418. Though the red color light of the three color lights are transmitted to the relay optical system 43, other arrangement where, for instance, blue color light is transmitted thereto is possible.

The optical device 44 is for modulating the incident light beam in accordance with image information to form a color image, which has three incident-side polarization plates 442, the liquid crystal panels 441R, 441G and 441B disposed on the after-stage of the respective incident-side polarization plates 442 as optical modulators, an irradiation-side polarization plate 443 disposed on the after-stage of the respective incident-side polarization plates 442, and a cross dichroic prism 444 as a color combining optical system.

The liquid crystal panels 441R, 441G and 441B use, for instance, a polysilicon TFT as a switching element.

In the optical device 44, the color lights separated by the color-separating optical system 42 are modulated by the three crystal panels 441R, 441G and 441B, the incident-side polarization plate 442 and the irradiation-side polarization plate 443 in accordance with image information to form an optical image.

The incident-side polarization plate 442 transmits only a polarized light of a predetermined direction among the respective color lights separated by the color separating optical system 42 and absorbs the other light beam, which is constructed by forming a polarization film on a substrate of sapphire glass etc.

The irradiation-side polarization plate 443 is constructed in an approximately the same manner as the incident-side polarization plate 442, which transmits only a polarized light of a predetermined direction among the light beam irradiated by the liquid crystal panels 441 (441R, 441G and 441B) and absorbs the other light beam.

The polarization axes of the incident-side polarization plate 442 and the irradiation-side polarization plate 443 are set orthogonal with each other.

The cross-dichroic prism 444 combines the optical image irradiated by the irradiation-side polarization plate 443 and modulated for respective color lights to form a color image.

A dielectric multi-layer film for reflecting red color light and a dielectric multi-layer film for reflecting blue color light are formed along boundary of four right-angled prisms of the cross dichroic prism 444, the dielectric multi-layer films combining three color lights.

The above-described liquid crystal panels 441, the irradiation-side polarization plate 443 and the cross dichroic prism 444 are constructed as an integrated unit of optical device body 45. Incidentally, the incident-side polarization plate 442 is slidably fitted and attached to a groove (not shown) formed on the light guide 47.

Though not specifically shown, the optical device body 45 has the cross dichroic prism 444, a metal base for supporting the cross dichroic prism 444 from the lower side, a metal holding plate for holding the incident-side polarization plate 443 attached to the light-beam incident end of the cross dichroic prism 444, and liquid crystal panels 441 (441R, 441G and 441B) held by four pins 453 attached to the light-beam-incident side of the holding plate. A predetermined gap is secured between the holding plate and the liquid crystal panel 441, so that the cooling air is flowed through the gap.

A right-angle prism 48 is located on light-irradiation side of the cross dichroic prism 444 of the optical device 44, which bends and reflects the color image combined by the cross dichroic prism 444 in a direction of the projection lens 46, i.e. bends and reflects the forwardly-irradiated color image in upward direction.

The projection lens 46 enlarges the color image reflected by the right-angle prism 48 to project on the reflection mirror 30. The projection lens 46 is supported by a support member screwed to the rotary position adjuster 204 (see FIG. 5).

As shown in FIG. 6, a box-shaped cover 49A having open upper side is provided around the projection side of the projection lens 46. An opening for securing optical path of the projected optical image is formed around the upper side 133 of the lower cabinet 13. The cover 49A abuts to the surrounding of the opening through an elastic member to enclose the opening.

The above-described optical systems 41 to 44 and 48 are accommodated in a light guide 47 made of synthetic resin as an optical component casing shown in FIG. 7.

Though specific illustration of the inside of the light guide 47 is omitted, as shown in FIG. 7, the light guide 47 has a lower light guide 471 having the groove for the respective optical components 412 to 415, 418, 421 to 423, 431 to 434 and 442 (not shown) to be slidably fitted from the above, and a lid-shaped lower light guide 472 for closing the upper opening side of the lower light guide 471.

As shown in FIG. 1, the screen unit 50 is a transmissive screen on which the optical image enlarged by the projection lens 46 of the optical unit 401 and reflected by the reflection mirror 30 is projected from the backside. The screen unit 50 has a screen 51 and a screen cover 52 for accommodating the screen 51 with the front side of the screen 51 being exposed.

The screen 51 is of four-layer construction of diffusion plate, Fresnel sheet, lenticule sheet and protection plate in an order from the side near the incident light, i.e. backside. The light beam irradiated by the projection lens and reflected by the reflection mirror is diffused by the diffusion plate and parallelized by the Fresnel sheet, which is diffused by optical beads constituting the lenticule sheet to obtain a display image.

As shown in FIG. 2, speaker boxes 70 are respectively attached to the right and left lateral sides 16 of the upper cabinet 12 as a body independent of the upper cabinet 12. The speaker box 70 is a box-shaped body working as a speaker. The front side of the speaker box 70 is substantially flush with the front side of the screen unit 50 so that the both sides are approximately parallel in vertical direction.

As shown in FIG. 1, the screen cover 52 is fixed to the upper cabinet 12 with the screen 51 being accommodated and the front side 18 of the upper cabinet 12 and the front side of the speaker box 70 being covered.

[4. Structure of Controller]

The structure of the controller as a component of the control board 402 will be described below.

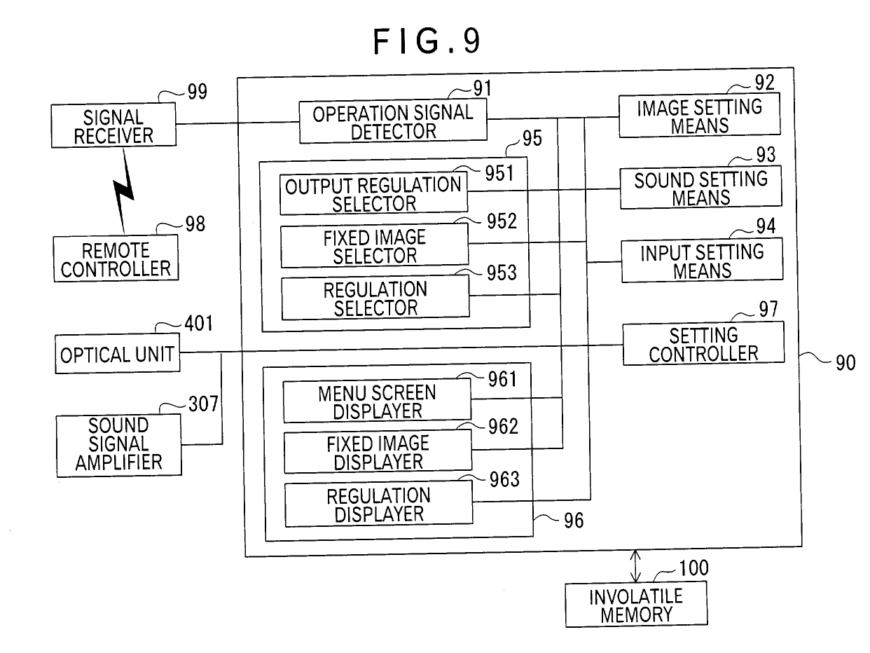

As shown in FIG. 9, a controller 90 has an operation signal detector 91, an image setting means 92, a sound setting means 93, an input setting means 94, a function setting means 94, an output 96 and a setting controller 97 and is connected with a signal receiver 99 that receives an operation signal from a remote controller 98 and an involatile memory 100 such as EEPROM and flash memory.

The above means 91 to 97 are stored in the involatile memory 100 as a program. The operation signal detector 91 and the setting controller 97 are fetched to the controller 90 when the rear projector 1 is actuated. The rest of the means 92 to 96 are operated after actuating the rear projector 1 being fetched by the controller 90 as necessary. The respective means 91 to 97 are written on the involatile memory 100 together with the other program during manufacturing process, which may be stored in other media such as CD-ROM.

The operation signal detector 91 detects an operation signal transmitted when the operation switch of the remote controller 98 is operated and/or an operation signal outputted when the operation switch provided on the body of the rear projector 1. Though not illustrated, the operation switch of the remote controller 98 etc. may be, for instance, up, down, right and left movement keys, return key, menu switch and muting switch.

The operation signal detector 91 determines the type of the operation signal from the remote controller 98 etc. to fetch the image setting means 92, the sound setting means 93 the input setting means 94 and the function setting means 95 on the controller 90 as required, and actuates the fetched component.

The image setting means 92 determines image displayed on the rear projector 1. When the image setting means 92 is operated, items such as tracking, synchronization, brightness, contrast, sharpness and resolution are displayed on the menu screen displayed by below-described menu screen displayer 961, so that an operator can conduct various screen setting by operating the remote controller 98 etc.

The sound setting means 93 sets sound output of the rear projector 1. When the sound setting means 93 is actuated, items such as sound volume, sound quality, output speaker are displayed, and sound output setting can be conducted by the remote controller 98 as in the above.

The input setting means 94 is for selecting and setting from which one of the various input terminals provided on the above-described interface board 80 the signal is received. In the present embodiment, the interface board 80 is provided with an RGB signal input system, a composite signal input system and a component signal input system, the respective input systems having a plurality of terminals.

Though not illustrated, the remote controller 98 is provided with buttons corresponding to the respective signal input systems. When the input setting means 94 is operated, a screen on which the respective signal input systems and input terminals are arranged in matrix is displayed and the input terminal of the signal input systems can be selected by pressing the button of the signal input system a plurality of times by the remote controller 98.

The setting controller 97 is a portion that outputs control signal to the optical unit 401 as an image output portion and the sound signal amplifier as a sound output portion in accordance with the setting value set by the image setting means 92, the sound setting means 93, the input setting means 94 and the function setting means 95 based on the signal detected by the operation signal detector 91. The various operations set on the menu screen are conducted by the setting controller 97.

The function setting means 95 sets functions other than image, sound and input, which includes an output regulation selector 951, a fixed image selector 952, and a regulation selector 953.

Though described in detail below, when the function setting means 95 is actuated, items such as output regulation, fixed image selection and regulation selection are displayed, and the above-described respective means 951 to 953 are actuated in accordance with the selected item.

The output regulation selector 951 sets output regulation of the image output and sound output, i.e. muting. In the present embodiment, “image/sound mute” and “sound mute” are displayed as a choice on a screen to urge the operator to select. Incidentally, muting operation is conducted when the operator presses the muting switch provided on the remote controller 98. When the muting switch is pressed, either one of the muting operations is selected and performed.

The fixed image selector 952 selects a fixed image displayed instead of the screen of the rear projector 1 when the image of the rear projector 1 is muted. In the present embodiment, fixed image of black or blue color can be selected.

The regulation selector 953 selects whether regulated condition is displayed on the screen or not while muting the screen. When the image is muted while displaying condition is selected, a message such as “now muting the screen” is displayed on the center of the screen.

The output 96 outputs image output in accordance with the type of the operation signal detected by the operation signal detector 91, which has a menu screen displayer 961, a fixed image displayer 962 and regulation displayer 963.

When the operation signal detector 91 detects an operation signal indicating that the menu-displaying switch is pressed, the menu screen displayer 961 displays a predetermined menu screen on the screen of the rear projector 1, based on which the operator conducts various settings.

The fixed image displayer 962 displays the fixed image on the screen in accordance with the result selected by the above-described fixed image selector 952 on condition that the muting switch of the remote controller 98 etc. is pressed.

The regulation displayer 963 indicates that the screen is regulated in accordance with the result selected by the above-described regulation selector 953 on the screen on condition that the muting switch of the remote controller 98 etc. is pressed.

[5. Function of Controller]

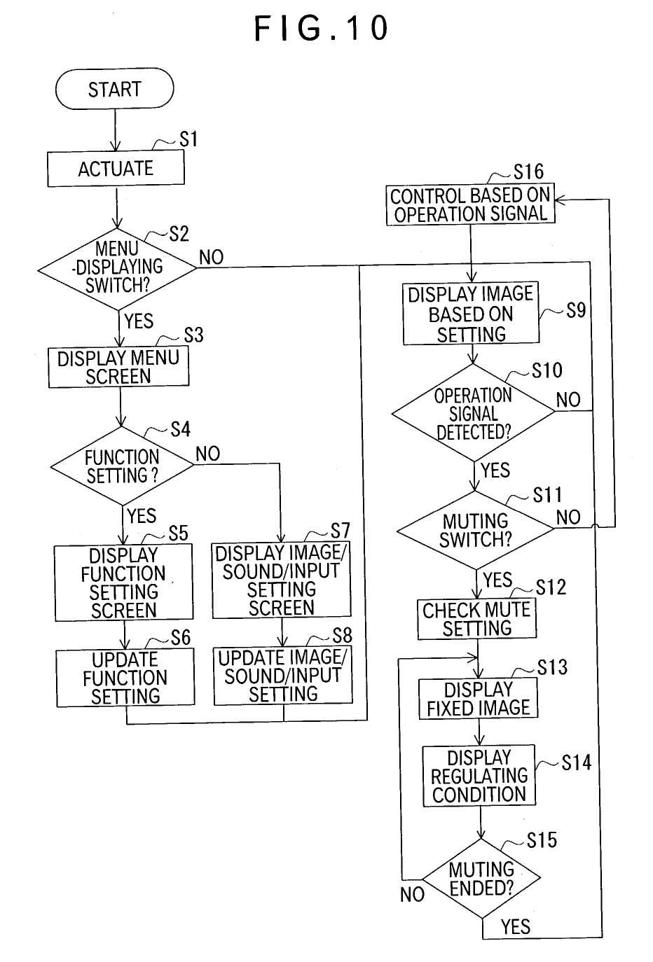

Next, the function of the above-described controller 90 will be described below with reference to flowchart shown in FIG. 10.

(1) Initially, when the rear projector 1 is actuated (process 1), the operation signal detector 91 and the setting controller 97 are actuated on the controller 90. The operation signal detector 91 monitors whether the operation signal for displaying the menu screen is inputted by the operation of the menu-displaying switch of the remote controller 98 etc. or not. When the menu-displaying switch is not pressed, the setting at the last time the projector is turned off is fetched from the involatile memory 100 to display an image (step S9).

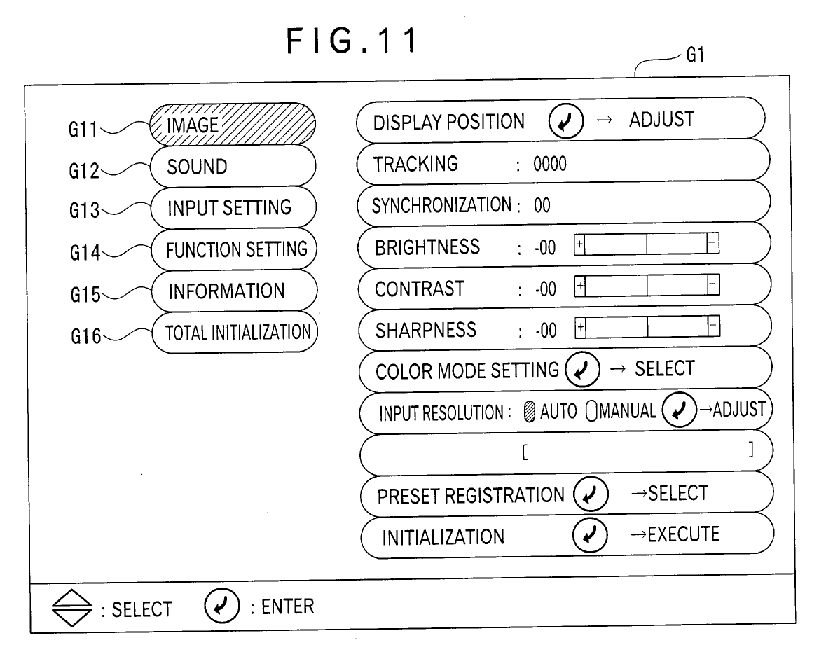

(2) When the operation signal detector 91 detects an operation signal to display a menu screen from the remote controller 98 etc. (step S2), the setting controller 97 outputs a control signal to the menu screen displayer 961 to display a menu screen G1 as shown in FIG. 11 (step S3) to urge the operator to select setting items. Incidentally, the menu screen G1 in the present embodiment has items G11 to G15 of image, sound, input, function, information and total initialization displayed thereon, where up/down key of the remote controller 98 is operated to move the cursor position of the items and return key is pressed to select the setting item.

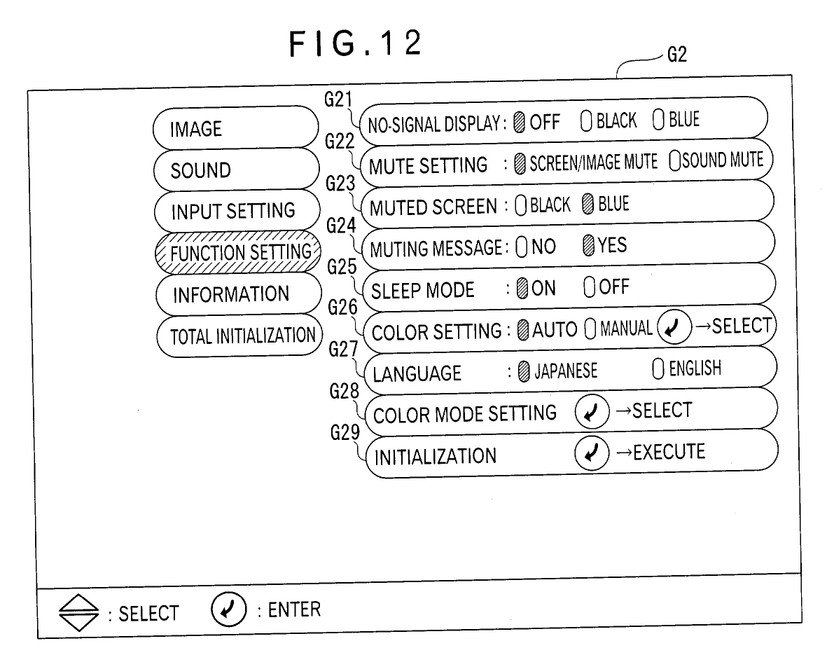

(3) When the operator operates the remote controller 98 etc. on the menu screen G1 to select function setting (step S4), the output regulation selector 951 displays a function setting selecting screen G2 shown in FIG. 12 based on the operation signal to urge the operator to select (step S5). On the function setting selecting screen G2, the cursor is moved to no-signal display setting item G21, mute setting item G22, mute screen selecting item G23, mute message setting item G24, sleep mode setting item G25, color setting item G26, language setting item G27, color mode setting item G28 and initialization item G29 on the right side of the screen by operating vertical direction key of the remote controller 98 etc. to conduct each setting. For instance, in conducting mute setting as a selection of output regulation display, horizontal direction keys of the remote controller 98 is operated to select either one of image/sound mute or sound mute is selected and determined by the return key. The same process is conducted on the mute screen selecting item G23 and mute message setting item G24.

(4) When the operator completed function setting operation, the setting controller 97 updates function setting of the rear projector 1 based on the selected result (step S6), and stores the setting value on RAM (Random Access Memory) not shown in FIG. 10.

(5) On the other hand, when image setting etc. is selected on the menu screen G1, the setting screen corresponding to respective setting is displayed as in setting the function (step S7), the setting controller 97 updates the setting based on the selected result (step S8).

(6) When the setting on the menu screen GI is terminated, the controller 90 displays the image in accordance with the inputted image signal by the optical unit 401 and outputs sound in accordance with the inputted sound signal by the sound signal amplifier 307 based on the setting (step S9).

(7) While displaying image and outputting sound by the rear projector 1, the operation signal detector 91 monitors the signal receiver 99 to detect presence of the operation signal from the remote controller 98 etc (step S10).

(8) The detection signal detector 91 determines the operation type when the detection signal detector 91 detects the operation signal of the remote controller 98 etc (step S11). When the operation signal detector 91 judges that the operation type is other than pressing the muting switch, outputs to the effect to the setting controller 97. After the setting controller 97 conducts control in accordance therewith, normal display screen is restored (step S16).

(9) When the operation signal detector 91 judges that the muting switch is pressed, the setting controller 97 checks mute setting by searching in the RAM storing the selected result of the items G22, G23 and G24 on the function setting selecting screen G2 (step S12). According to the setting of FIG. 12, since “image/sound mute” is selected on the item G22, “blue screen” is selected on the item G23 and “message yes” is selected on the item G24, the setting controller 97 outputs a control signal to the fixed image displayer 962 to regulate displayed image in accordance with the image signal currently inputted and blue screen image is displayed (step S13). Simultaneously, the setting controller 97 outputs a control signal to the regulation displayer 963 to display a message “screen muting now” on the blue screen.

(10) Further, the setting controller 97 outputs a control signal to the sound signal amplifier 307 to regulate sound output from a speaker etc.

(11) The operation signal detector 91 monitors whether the muting switch of the remote controller 98 etc. is pressed again or not (step S15). While the muting switch is not pressed, fixed image, regulation display and regulation sound output are maintained.

(12) When the muting switch is pressed again, the setting controller 97 removes the muting condition in accordance with muting setting, and returns to normal display screen based on inputted image signal.

[6. Effect of Embodiment]

According to the above-described embodiment, following advantages can be obtained.

(1) Since the output regulation selector 951 is provided, whether regulating both of image and sound or mere sound regulation can be selected, so that muting condition of image and sound can be selected in accordance with the usage such as presentation and personal use.

(2) Since the muting can be selected on the function setting selecting screen G2 by selecting function setting on the menu screen G1, the muting setting can be easily conducted only by operating the switch of the remote controller 98 etc.

(3) Since the fixed image such as the blue screen is displayed by the fixed image displayer 962 while muting the image output, the viewer does not feel unpleasant unlike the sandstorm-like screen, so that image muting display can be of little annoyance to the viewer.

(4) Since screen muting condition is indicated by the regulation displayer 963, whether the regulation of the muting screen is caused by blocking input of the image signal by the muting switch or not can be recognized at sight.

(5) Since the rear projector 1 is provided with the above-described function of selecting muting setting of the image and screen, the rear projector 1 can be widely used for variety of usages such as personal use of home-theater etc. and presentation.

[7. Modification of Embodiment]

The scope of the present invention is not restricted to the above-described embodiments, but includes following modifications.

In the above-described embodiment, though the output regulation selector 951 can select image setting from “image/sound mute” and “sound mute” on the function setting selecting screen G2 in the menu screen G1, “image mute” may be added as another option.

Though the fixed image can be selected from “black” and “blue” on the function setting selecting screen G2 in the menu screen G1, image data such as photograph and a picture may be stored in the involatile memory 100 and the stored data may be added as an option.

Though the present invention is applied to the rear projector 1, the present invention may also be applied to image display such as plasma display.

Though involatile memory is used as a recording media of the program, any computer-readable recording medium, e.g. magnetic recording media such as floppy disk and hard disk and optical recording media such as CD-ROM, MO (Magnet-Optical disk) and DVD (Digital Video Disk) can be used.

Specific structure and arrangement of components in implementing the present invention may be designed in any manner as long as an object of the present invention can be achieved.

What is claimed is:

1. An image display comprising:
an image output portion that forms and displays an optical image in accordance with inputted image signal;
a sound output portion that outputs sound in accordance with an inputted sound signal; and
an output regulation selector that selects regulation on either one or both of an image output of the image output portion and the sound by the sound output portion.

2. The image display according to claim 1,
wherein the output regulator displays a predetermined menu screen on the image output portion and selects a setting on the menu screen.

3. The image display according to claim 1, further comprising a fixed image displayer that displays a predetermined fixed image of the image output portion when the image output of the image output portion is regulated.

4. The image display according to claim 1, further comprising a regulation displayer that indicates regulation of the image output of the image output portion when the image output of the image output portion is regulated.

5. The image display according to claim 1, further comprising:
a controller that controls the image output portion and the sound output portion; and
a storage storing a software that is operated by the controller in actuating the image display,
wherein the output regulation selector is stored in the storage.

6. The image display according to claim 1, further comprising:
an electric optical device that modulates a light beam irradiated by a light source in accordance with the inputted image signal to form the optical image; and
a projection optical system that enlarges and projects the optical image.

7. A computer-readable program that controls an image display, the image display having: an image output portion that forms and displays an optical image in accordance with inputted image signal; a sound output portion that outputs sound in -accordance with an inputted sound signal; and a controller that controls the image output portion and the sound output portion,
the program making the controller work as an output regulator that regulates either one or both of an image output of image output portion and the sound by the sound output portion.
